(19) United States
(12) Patent Application Publication
(10) Pub. No.: US 2014/0192941 A1
(43) Pub. Date: Jul. 10, 2014

(54) Method of acceleration of nuclear transmutation of isotopes by carrying out exothermic reactions

(71) Applicant: Lev Bernstein, Arlington, VA (US)

(72) Inventor: Lev Bernstein, Arlington, VA (US)

(21) Appl. No.: 13/605,032

(22) Filed: Sep. 6, 2012

Related U.S. Application Data
(60) Provisional application No. 61/551,652, filed on Oct. 26, 2011.

(51) Int. Cl. G21G 7/00

(52) U.S. Cl. CPC G21G 7/00
USPC 376/156

(57) ABSTRACT

Methods for acceleration of nuclear transmutation of tritium and radioactive isotopes of metals, and decontamination of metals contaminated with radioactive isotopes by destroying radioactive isotopes to a required level of residual radioactive inventory in metals with simultaneous release of thermal energy via stimulating accelerated transmutation with the half-life parameters describing kinetics of radioactive isotope destruction much shorter than their generally accepted half-life. The stimulus is applied to radioactive metals by placing them into a chamber, exposing them to gaseous substances of the group of hydrogen, deuterium, tritium, or a mixture of these isotopes in a molecular hydrogen form for said gaseous substances to be absorbed by the metals, heating the metals to a temperature of at least 200° C. and maintaining at the said temperature. Exothermic reactions of non-radioactive metals with deuterium, tritium, or a mixture of these isotopes in a molecular hydrogen form release a significant amount of energy.

### FIELD OF THE INVENTION

The invention is in the fields of waste management in the nuclear and other industries allowing an expedited disposal of radioactive materials by significantly reducing the contamination of metals with radioactive isotopes, controlling the recovery and transmutation of radioactive isotopes, and easing the requirement for storage of the treated radioactive materials; and energy production.

### BACKGROUND OF THE INVENTION

A disposal of radioactive materials is one of the most important issues in nuclear industry. There are two main approaches to the radioactive materials disposal: decontamination and/or storage until radioactivity is decayed to allow a further utilization. The radioactive decay of an isotope is measured in terms of “half-life,” the duration of a period necessary to reduce the radioactivity of the isotope by half. The half-life values of the most common decay processes are well known.

The current fundamental approach in science considers the half-life as intrinsic characteristics of each isotope that could not be affected by changes in the surrounding environment. However, an analysis of published scientific literature showed that certain direct and indirect experimental data challenged this approach.

Torikai et al. [Y. Torikai, R.-D. Penzhom, M. Matsuyama and K. Watanabe, “Tritium Uptake by SS316 and its Decontamination,” J. Nucl. Materials, 329-333, 1624-1628 (2004)] studied the detritiation of stainless steel samples using various purging gases (argon, air and argon+3% H₂). They purged samples heated up to a temperature of 673 K, collected tritium removed from these samples (hereafter, the removed tritium), determined the activity of the removed tritium, and stated that all sorbed tritium was removed from the sample. They determined an initial concentration of tritium in a sample indirectly based on the tritium content measured for another sample loaded at the same time, i.e. means they did not know the exact amount of tritium sorbed in the sample studied, which made it very difficult to verify the tritium balance after the test. They also did not measure the residual tritium activity of the sample after the completion of the detritiation, which made impossible to verify the tritium balance during the test. However, they stated without any experimental proof that all sorbed tritium can be thermally released during heating the sample at a temperature higher than 673 K. It is also necessary to emphasize that the authors did not mention anything about the flow rates of the purge agents used and a void volume of the reactor where the sample was placed. However, the ratio between the flow rate of a purge agent and a void volume of a reactor with a sample in it (hereafter, gas exchange rate of the purge agent) represents one of the most important parameters in the detritiation process. It is necessary to emphasize that Torikai et al. interpreted the results of the experiments assuming that a half-life of tritium decay has a generally accepted value.

It is taught in U.S. Pat. No. 5,076,971 that applying electrical potential of 50 kilovolts to 500 kilovolts to contaminated metals that contain alpha, beta, or gamma radioactivity and have been placed in a Van de Graph accelerator would significantly accelerate decay. It was shown that the decay for alpha emitter, thorium 230 (₉₀Th²³⁰), can be accelerated by a factor of 4.49*10⁴ while for beta minus emitter, thallium 204 (₈₁Tl²⁰⁴), a respective acceleration factor of just 15 was measured. This significant difference can be explained by the fact that alpha decay process is controlled by the Coulomb barrier, which was modified by applying electrical potential, while beta decay is controlled by electron-nucleus contact.

Tritium decay is based on the transmutation reaction resulting in formation of ₂He³, beta particle, and antineutrino. This transmutation reaction can be monitored by measuring the amounts of He³ formed and/or beta particles released. Most researchers have been measuring, beta particles because it is much easier in many experimental conditions. However, measuring He³ would make it easier to reach a conclusion about a rate of tritium decay.

For example, Akulov and Mamyrin used mass-spectrometry for measuring He³ concentration in gas phase during tritium decay experiments [Yu. A. Akulov and B. A. Mamyrin, Isotopic-helium mass-spectrometry method of tritium beta-decay study, Uspehi Phizicheskih Nauk, 173 (2003), N11, 1187-1197]. They proved that the half-life for molecular tritium was by 11.5 days longer than the half-life for atomic tritium. Based on experimental atomic tritium decay data and their model for possible atomic tritium decay reactions, they also calculated triton decay half-life that turned out to be by 9.5 days shorter than the half-life for atomic tritium decay. These data also prove that the experimental surrounding can affect beta decay rates.

Reifenschweller, in his experiments with tritium, counted beta particles formed during decay [O. Reifenschweller, Reduced radioactivity of tritium in small titanium particles, Physics Letters A, 184 (1994), 149-153] and concluded that decelerated decay for beta radioactive tritium during the detritiation of a titanium sample (of 48 mg) consisting of monocrystalline particles of about 15 nm in diameter arranged in chains and loaded with tritium in the hydrogen form (100 mCi T₂) was the only possible explanation for his experimental data. This study deserves a detailed discussion. The sample was slowly heated to 450° C. within 10 hours (at a specific rate per sample unit mass of 15.6° C./(min*g)), and the electron current was measured and attributed to beta particles released to gas phase of the volume where the required pressure was kept using a diffusion pump. It was shown that the electron current went down sharply to 72% of its initial value in the temperature range of 115-160° C. followed by a slower decrease to 60% at 275° C. With a further temperature increase, the current returned to its initial value at 360° C., and then went down due to complete decomposition of the titanium preparation, which indicated that most of tritium was removed from the metal sample. In another experiment, another sample was heated 5 times faster (at a specific rate per sample unit mass of 78.1° C./(min*g)) and there was no reduction in the electron current measured.

Reifenschweller stated that no tritium escaped from the titanium layer in the temperature range of 115-275° C., and this statement inevitably let him to conclude that the tritium decay constant decreases in this temperature range. The statement that “no tritium escaped from titanium layer in the temperature range of 115-275° C.” was based on the fact that an increase in a temperature from 275° C. to 360° C. led to “re-increase of count rate.” In order to prove this statement, it was needed to estimate tritium activity balance at each step of the process; however, the residual tritium inventory in titanium particles and a quantity of tritium released during the detritiation process and pumped out by the diffusion pump were not analyzed. Considering a small mass of titanium and its low tritium activity, it was probably impossible to measure in those experiments a concentration of tritium removed with the gas phase, a residual tritium activity of the sample, and/or a concentration of He³ formed during tritium decay and remained in the sample after completion of the experiments.

An analysis of the aforementioned publications regarding the beta radioactive isotopes decay leads to a conclusion that radioactive decay acceleration is possible by applying an electrical potential to beta radioactive metals (U.S. Pat. No. 5,076,971), and is not possible by applying heating to metals contaminated with beta radioactive tritium. Moreover, this analysis could lead one to conclude that the low temperature heating of metals either does not change a half-life of tritium (Y. Torikai, et al.), or even increases it (Reifenschweller).

Assuming that Reifenschweller's conclusion on a reduction of tritium decay constant in a temperature range of 115-275° C. is correct, one can conclude that tritium, which has not yet decayed, would stay in the sample and could be found there if the detritiation process was completed at 275° C. Unfortunately, the detritiation process was completed after practically all tritium was removed from the sample; therefore, this fact was not verified. Moreover, our analysis of the Reifenschweller's experimental data led us to a different conclusion about apparent tritium decay constant.

Specifically, a decrease in the beta particles concentration transferred to the gas phase could occur due to several reasons. It could be a depletion of the tritium concentration on the sample surface due to diffusion of the tritium-containing molecules inside the metal from the metal surface if a tritium distribution across the metallic sample was uneven (and, respectively, due to a reduction in the count of beta particles transferred to gas phase from the surfaces of the sample), or due to a low rate of tritium transfer from a depth of the sample to its surface, which is below the tritium decay rate. Two other reasons for the decrease in the beta particles concentration transferred to the gas phase are possible: beta bound decay, which means that an emitted beta particle takes a position of electron at He³ orbit, and/or nuclear reactions with tritium participation that lead to formation of stable isotopes or non-beta radioactive isotopes that stay in the metal. In each case, no radioactivity would be produced, and the only direct way to prove that tritium did not disappear but was transformed via decay or other nuclear reactions during the experiments is to measure the concentration of He³ or new isotopes formed. Any of these phenomena could explain why the electron current measured in the Reifenschweller's experiments in the temperature range of 115-275° C. went down. Moreover, the author did not attempt to maintain any steady temperature (for example, 275° C.) within a certain time interval to verify how the process progress in the temperature range of 115-275° C. would be consistent with his understanding of the process. Therefore, there was no experimental proof there that the tritium decay constant was reduced or increased and no definite conclusion on variation of the tritium decay constant can be made based on Reifenschweller's experiments. It is also necessary to stress that, according to the author's data, a five-fold increase in a temperature rate (not shown in Reifenschweller's FIG. 2) has changed the kinetics of the detritiation process leading to a standard desorption curve when a tritium concentration transferred to the gas phase does not have an abnormality such as shown in Reifenschweller's FIG. 2. This also shows that if another process, except of tritium desorption, occurs inside the metal, a temperature increase rate for samples of very low mass would determine kinetics of both processes, and as such would play a very important role in the detritiation process.

Heating the sample to a temperature of greater than 300° C. started a significant removal of tritium from the sample (See FIG. 2, Reifenschweller). As in any detritiation process (removal of tritium from the sample) the flow of tritium transferred to gas phase increases within a certain time with an increase in a temperature and then, due to tritium depletion in the sample, the tritium flow goes down. A maximum concentration of tritium (respectfully, the electron current of the beta particles measured) removed from the sample during this detritiation process depends on the total tritium activity and its distribution in the sample. Therefore, a maximum electron current caused by beta particles could only fortuitously coincide with the initial current; existence of the maximum does not prove that tritium did not escape the sample earlier in this experiment. To find out what has happened to the tritium after the detritiation process has been completed, the metal should be analyzed for a residual tritium inventory. Finding tritium in the metal could be a proof that no tritium “disappearance” occurs, and a balance of the tritium activity in the experiments allows one to estimate whether the tritium decay constant was changed. However, if the tritium balances for the experiments were not converged, and analytical procedures used for detection and measurement of tritium in all phases involved in the experiments were correct, it would be possible to conclude that beta bound decay or other nuclear reactions involving tritium occurred. The beta bound decay and/or nuclear reactions involving tritium and leading to the formation of stable isotopes when no radioactivity is produced can be called a destruction of radioactive isotopes.

Irrespectively of a mechanism of nuclear reactions involving tritium—radioactive decay and/or nuclear reactions with tritium participation—certain amount of energy is released in these experiments. Therefore, tritium in metals could be used as a source of energy production.

A search for economically viable alternative sources of energy production has been going on for the last several decades. Recently, an economically viable method of energy production based on exothermic reaction of nickel with hydrogen was proposed by A. Rossi (Italian patent No. 0001387256 issued on 6 Apr. 2011). According to the patent, a highly efficient exothermal reaction between nickel atoms and hydrogen atoms takes place in a tube, preferably, though not exclusively made of a metal, filled with a nickel powder and heated to a high temperature preferably, though not necessarily, of 150 to 500° C., by injecting hydrogen into the said metal tube with the said nickel powder being pressurized, preferably, though not necessarily, to a pressure of 2 to 20 bars. In the exothermal reaction described in the patent, the hydrogen nuclei are compressed around the metal atom nuclei (as the capability of nickel to absorb hydrogen is high), while the said high temperature generates inter-nuclear percussions which are made stronger by the catalytic action of other optional undisclosed elements, thereby triggering a capture of a proton by the nickel powder, with a consequent transformation of nickel to copper and a beta+ decay of the latter to a nickel nucleus having a mass larger by a unit than that of the original nickel.

The said patent did not specify an isotopic composition of nickel used for the experiments; therefore, for a purpose of estimating heat release in this reaction, we used an isotopic composition of nickel with an abundance of the stable isotopes existing on the Earth. Table 1 shows possible products of the nuclear reactions of nickel isotopes with hydrogen atoms. For the purpose of our estimates, cross sections for all isotopes are assumed to be identical. An energy released per each nuclear reaction of nickel isotopes is estimated based on Einstein's equation, ΔE=Δmc². As can be seen from Table 1, each nickel isotope can theoretically react with hydrogen atom. Assuming that all nuclear reactions of each isotope of a nickel sample with hydrogen atoms are going on in parallel, energy released by g-atom of nickel (2.38E+24 MeV) is calculated based on stoichiometric concentrations of the nickel stable isotopes. Moreover, most of nickel stable isotopes will be mainly transformed to stable ₂₉Cu⁶³ isotope provided a sufficient amount of hydrogen atoms is available.

TABLE 1
Estimate of energy release during nuclear reactions of stable nickel isotopes with hydrogen atoms

| | | | Characteristics of | | ΔE, | | | | |
|---|---|---|---|---|---|---|---|---|---|
| | | | product of reaction | | MeV | | Decay product | | |
| Ni Characteristics | | | (Ni + H) | | per | ΔE, MeV | | Daughter's | |
| Atomic | | | Atomic | | atom of | per g- | | isotope, | |
| mass | | Isotope | mass | Isotope | each | atom of | Daughter's | Atomic | Isotope |
| ₂₈Ni | Abundance | status | ₂₉Cu | status | isotope | metal | isotope | Number | status |
| 58 | 68.077% | Stable | 59 | Radioactive | 3.42 | 2.38E+24 | Ni | 59 | Radioactive |
| 59 | | Radioactive | 60 | Radioactive | 4.48 | | Ni | 60 | Stable |
| 60 | 26.223% | Stable | 61 | Radioactive | 4.80 | | Ni | 61 | Stable |
| 61 | 1.140% | Stable | 62 | Radioactive | 5.87 | | Ni | 62 | Stable |
| 62 | 3.634% | Stable | 63 | Stable | 6.12 | | | | |
| 63 | | Radioactive | 64 | Radioactive | 7.20 | | Ni (61%) | 64 | Stable |
| | | | | | | | Zn (34%) | | |
| 64 | 0.926% | Stable | 65 | Stable | 7.45 | | | | |

### SUMMARY OF THE INVENTION

According to the invention, the metals can be decontaminated from high level of activity to intermediate and/or to low level of activity, which allows significantly reducing cost of radioactive metals storage and utilizing some of the materials. Transformation of tritium in tritium-contaminated metals results in a release of a significant amount of energy; therefore, carrying out exothermic reactions involving tritium can be used as an energy source. The method can find an application in disposal of radioactive wastes and energy production.

The present invention provides a method for decontamination of metals contaminated with radioactive isotopes that includes a significant destruction of a source of the radioactivity. The metals contaminated with radioactive isotopes preliminary loaded with hydrogen, or its isotopes or a mixture of the isotopes in molecular form are placed into a chamber and heated to at least 200° C. within a predetermined time, and is maintained at this steady temperature for a period of such a duration that is sufficiently long to ensure that residual activity of a radioactive isotope in the samples is sufficiently low for allowing storage under assigned conditions, and any other utilization of the metals. According to one embodiment, the chamber's volume during the heating is purged by gases inflammable and inexplosive in this condition. According to another embodiment, the chamber's volume is not purged during the heating but is purged after the heating to remove and collect radioactive products of the decontamination process. The detritiation process of tritium-contaminated metals can be controlled by gas exchange rate of the purge agent. The optimal gas exchange rate at given temperatures allows to maximize tritium transfer from the metal to gas phase and as such facilitates return of tritium to secondary use. A level of metal decontamination allows one to decide how to handle the decontaminated metal subsequently. For example, a metal with a high level of radioactivity can be reduced to one with intermediate or low level of radioactivity, which either satisfies requirements for storage of radioactive waste, or even can be utilized as non-radioactive waste.

The present invention is based upon the fact that the destruction of radioactive isotopes, which contaminate metals, is stimulated by heating the metals in the aforementioned conditions leading to the half-life parameter describing the kinetics of radioactive isotope destruction significantly greater than the generally accepted half-life of the radioactive isotopes. The heating of the contaminated metals with controlling gas exchange rates, thereon the Applicants' invention is based on, differs from those known in prior art where the gas exchange rate was not controlled, destruction of tritium as a radioactivity source was not known and ability to control tritium destruction using gas exchange rate and process temperature was not understood. The destruction of radioactive tritium is greater when the metals are heated without purge.

The present invention provides also to a method for carrying out exothermic reactions of metals and tritium at temperatures at least 200° C. The present invention is based upon the fact that use of tritium instead of hydrogen differs from those adapted in prior art and will release greater amount of energy than hydrogen in reactions with nickel. Reactions of tritium with other metals will also allow producing a significant amount of energy.

### BRIEF DESCRIPTION OF THE DRAWINGS

FIG. 1 is a block diagram to implement the method of decontamination of tritium-contaminated metals with destruction of tritium.

FIG. 2 is a block diagram to implement the method of decontamination of radioactive metals with destruction of radioactive isotopes.

FIG. 3 is a block diagram to implement the method of carrying exothermic reactions of metals with tritium.

### DETAILED DESCRIPTION OF THE INVENTION

Stainless steel (dimension of 12.0 cm×12.0 cm×4.9 cm; mass of 5645 g), copper alloy CuCrZr (dimension of 6.0 cm×6.0 cm×2.2 cm; mass of 710 g), tungsten (dimension of 4.0 cm×4.0 cm×1.0 cm; mass of 309 g), and beryllium (dimension of 3.0 cm×3.0 cm×1.0 cm; mass of 17 g) samples were loaded with tritium in molecular hydrogen form. Each detritiation experiment was conducted with one metal sample. The metal sample was placed into a chamber where it was heated to a given temperature at a temperature increase rate of 10° C./min and simultaneously purged with a purge agent controlling the gas exchange rate of the purge agent. The mixtures of argon+5 vol % hydrogen, nitrogen+5 vol % hydrogen, and argon+water vapor were used as a purge agent because mixtures of an inert gas with 5 vol % or less of hydrogen is inexplosive in a presence of air [Handbook of explosion prevention and protection, Edited by M. Hattwig, H. Steen, Wiley-VCH Verlag GmbH, 2002, section 3.1.5.2] and is inflammable [Material safety data sheet, Matheson TRI-GAS, Inc, prepared for US OSHA, CMA, ANSI and Canadian WHMIS Standards]. When a required operation temperature was achieved, the detritiation process continued for duration of 24 up to 90 hours, and the operation temperature was held stable during this period. The selection of a temperature increase rate of 10° C./min was limited by the equipment capability. Considering that (i) the smallest mass of the among the samples in our experiments exceeds by a factor of 350 the mass of each individual sample in Reifenschweller's experiments and (ii) the operation temperature was steadily maintained in our experiments while was not steadily maintained in Reifenschweller's experiments, we concluded that a rate of the temperature increase in our experiments cannot affect the detritiation process because the duration of temperature increase period required to heat samples to the operation temperature contributed no more than 5.5% to the overall time of the detritiation process.

The detritiation of each metal was studied at three different temperatures: 200° C., 500° C., and 800° C.; with the three aforementioned purge agents, and with various purge agent flow rates. A change in flow rate affects the kinetics of tritium desorption from metals and as such can affect other possible processes occurred inside the metal. During the detritiation experiments, the tritium transferred to gas phase and removed from the chamber with the flow of the purge agent was collected in a tritium collection system.

The balance of tritium activity for each experiment was determined based on the following formula that represents material balance of that tritium in the experiment:

A=B+C+D,

where A is the initial tritium inventory in a metal; B is the residual tritium inventory in the metal after the experiment; C is the tritium inventory transferred to gas phase and collected during the experiment; and D is the possible tritium activity that could escape during the length of the experiment due to, for example, leakage through a faulty air-tight barriers of an experimental system, and/or diffusion through the walls of the chamber.

Initial (A) and residual (B) tritium inventory and distribution in the samples were determined using radioluminography. Tritium stripped from the metal in the detritiation experiments was collected in the tritium collection system and tritium content in both molecular hydrogen and water vapor forms was measured individually using the liquid scintillation counting method. The sum of tritium activity in its molecular hydrogen and water vapor forms (C) was calculated.

Before the experiments, the chamber with a metal sample loaded with tritium was checked with a helium leak detector and showed no leakage. During the experiments the radiation level in the premises surrounding the experimental system was measured and was at a background level. After all experiments were completed, the walls of the chamber were cut, and the tritium activity and its distribution inside the walls of the chamber were measured. The result showed that tritium activity in the walls of the chamber was at a background level. These facts demonstrate that, within an accuracy of the measurements, the term D in the formula above is insignificant and was neglected in the further analysis. Therefore, the difference between an initial inventory of tritium in a metal sample (A) and a sum of the residual inventory of tritium in the metal sample (B) and collected activity removed from the metal sample (C) was determined. This difference determined as percentage of A as [1−(B+C)/A]*100% is referred to hereafter as disbalance.

All metal samples studied had a tritium disbalance, which increased with an increase in a temperature of the detritiation. Despite significant mass of the samples, the concentration of He³ formed was so low that it was impossible to detect it. Tritium disbalances are dependent on gas exchange rates (shown in parentheses) at a temperatures of 800° C. as follows:

Stainless steel—47-95.2% (6.0-0.1 h⁻¹)

Cu—77-99.6% (6.0-0.1 h⁻¹)

W—63-96.7% (6.0-0.1 h⁻¹)

Be—87-95.3% (80-0.1 h⁻¹)

Tritium disbalances at temperatures of 200° C. and 500° C. and optimal gas exchange rates determined at 800° C. for each metal specified (the latter figures are shown in the parentheses) are:

Stainless steel—78.8% (200° C., 6 h⁻¹) and 74.9% (500° C., 6 h⁻¹)

Cu—45.8% (200° C., 6 h⁻¹) and 87.5% (500° C., 6 h⁻¹)

W—39.1% (200° C., 6 h⁻¹) and 85.3% (500° C., 6 h⁻¹)

Be—45.7% (200° C., 80 W h⁻¹) and 94.6% (500° C., 80 h⁻¹)

An increase in the gas exchange rates for stainless steel, copper alloy, and tungsten from 0.1 h⁻¹ to 6 h⁻¹ using a mixture of 95 vol % argon with 5 vol % hydrogen as a purge agent and a temperature of 800° C. for the detritiation process leads to an increase in the fraction, C/A, of tritium inventory that could be removed from the samples and collected in the tritium collection system, and, respectively, to a decrease in the amount of tritium destroyed as a radioactivity source. However, an increase in the gas exchange rate above a level of 6 h⁻¹ does not significantly change the ratio between removed and transformed tritium for the detritiation of stainless steel, copper alloy, and tungsten, and as such the gas exchange of 6 h⁻¹ is practically the rate that allows the highest level of tritium recovery with the lowest level of tritium destruction as a radioactivity source.

An increase in the gas exchange rates for beryllium from 0.1 h⁻¹ to 80 h⁻¹ using a mixture of 95 vol % argon with 5 vol % hydrogen as a purge agent and a temperature of 800° C. for the detritiation process leads to an increase in the fraction of tritium inventory that could be removed from the samples and collected, C/A, and, respectively, to a decrease in the amount of tritium destroyed as a radioactivity source. However, an increase in the gas exchange rate above a level of 80 h⁻¹ does not significantly change the ratio between removed and destroyed tritium for the detritiation of beryllium, and as such the gas exchange of 80 h⁻¹ is practically the rate that allows the highest level of tritium recovery with the lowest level of tritium destruction as a radioactivity source.

As the aforementioned data demonstrate, it is possible to control the ratio between amounts of tritium removed and destroyed as a radioactivity source by heating the metals and by controlling the gas exchange rates of purge agents during the detritiation process.

Attributing disbalance in the material balance equation shown above to the nuclear transmutation of tritium (via unspecified nuclear reactions and/or beta bound decay) and applying the exponential formula of the radioactive decay to our experimental results allows one to determine the half-life parameter describing the kinetics of tritium destruction achieved during the detritiation process (T_{1/2 cal}) and compare it to the generally accepted half-life of tritium radioactive decay of 12.32 years. The ratios between the generally accepted half-life of tritium and the half-life parameter of tritium destruction obtained for various metals studied in these detritiation process are in the following ranges:

Stainless steel: 4.0E+3-2.0E+4 with the average ratio of 12.32/T_{1/2 cal}=1.0E+4

Cu: 4.0E+3-3.5E+4 with the average ratio of 12.32/T_{1/2 cal}=1.6E+4

W: 3.2E+3-2.5E+4 with the average ratio of 12.32/T_{1/2 cal}=1.5E+4

Be: 3.9E+3-2.0E+4 with the average ratio of 12.32/T_{1/2 cal}=1.5E+4

This means that the destruction of tritium as a radioactivity source via nuclear transmutation occurs in our experiments at a rate that is significantly faster than the generally accepted rate for the radioactive decay of tritium, i.e., the conditions of our experiments facilitate an acceleration of nuclear transmutation of tritium. A possible explanation of the acceleration is that a part of tritium atoms overcame the Coulomb barrier of nuclei of the metals and reacted with it. However, if tritium atom, which is larger than hydrogen atom, overcame the Coulomb barrier, then hydrogen can also overcome the Coulomb barrier in similar condition. This statement is supported by the data of the Rossi's experiments: hydrogen overcame the Coulomb barrier of nuclei of nickel, reacted with it and formed stable ₂₉Cu⁶³ isotope. Combining in our analysis the results of our and the Rossi's experiments, it is possible to conclude that a) not only hydrogen and tritium but also deuterium can also overcome the Coulomb barrier of nuclei of the metals; and b) any isotopes of metals can react with any of the following gaseous ingredients in a molecular hydrogen form: hydrogen, deuterium, tritium or a mixture of these isotopes provided the said ingredients are absorbed by the metals, and the condition of the experiment is such that the total mass of products of each nuclear reaction of the said ingredients with metals is less than the total mass of original participants of the reaction.

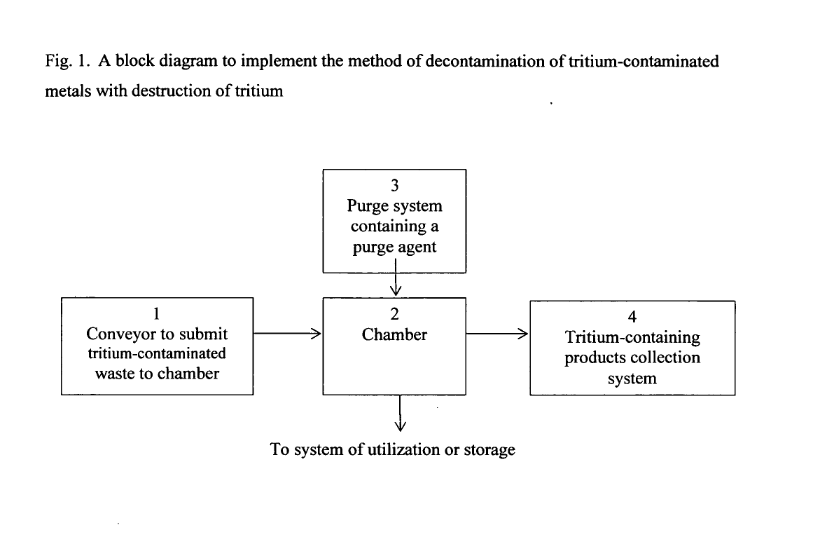

One of ordinary skill in the art armed with the present specification will readily appreciate the adaptability of the present invention to a practical application in its intended fields of use. For example, a block diagram of a presently preferred prophetic embodiment implementing the proposed method of decontamination of metals contaminated with tritium is shown in FIG. 1. As shown in FIG. 1, tritium-contaminated waste is submitted to an air-tight chamber 2 using a conveyor 1. The air-tight chamber 2 loaded with the waste is disconnected from the conveyor 1 and is heated up to a required temperature of at least 200° C.

In accordance with a presently preferred embodiment, it may be advantageous to supply a purge agent or the like from a purge system 3 to the chamber 2. After reaching the required temperature, the process of metal decontamination continues within a preliminary determined time. Suitable times may be determined by those of ordinary skill in the art through routine experimentation based on such factors as the volume of wastes, type of wastes, temperature, etc. After completion of the process within a predetermined time interval, an advantageous feature of this aspect of the invention is to continue supplying the purge agent to the chamber 2 to purge residual gaseous radioactive products to a collection system 4 or other further processing according to the principles of the present invention.

According to an alternative prophetic embodiment, no purge agent is submitted to the chamber 2. After reaching the required predetermined temperature, the process of metal decontamination continues for a predetermined time. After completion of the process within a required time interval, it may then be advantageous to submit a purge agent or the like from a purge system 3 to the chamber 2 to purge gaseous radioactive isotopes, which could be released during the process, to the collection system 4 or other area for further processing.

According to a presently preferred prophetic embodiment, and as will be appreciated by one of ordinary skill in the art, the collection system 4 is designed to prevent a release of the radioactive gases to the environment and/or to recover radioactive isotopes for a secondary use.

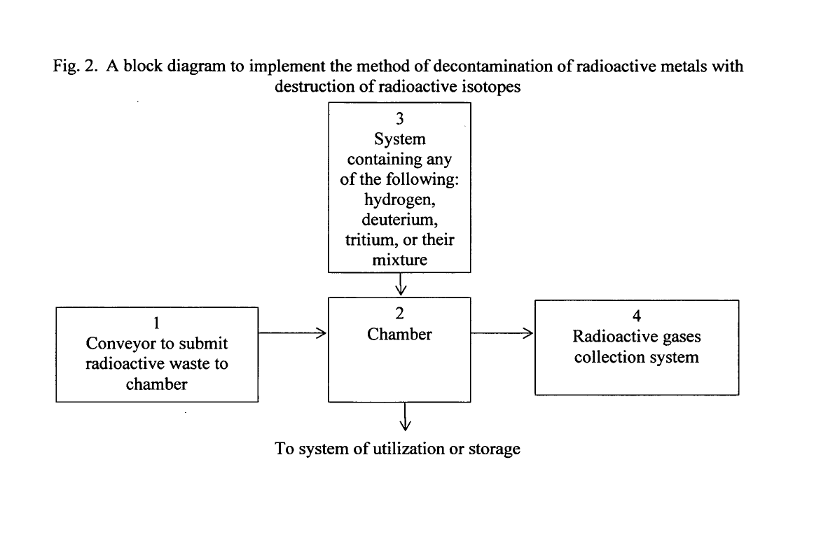

FIG. 2 depicts a block diagram of a presently preferred prophetic embodiment implementing the proposed method of decontamination of radioactive metals by destructing the radioactivity carrying out exothermic reactions of metals and any of the following: hydrogen, deuterium, tritium, or a mixture of these isotopes in a molecular hydrogen form according to the present invention. In operation, it is contemplated that radioactive metals, which do not contain tritium, are submitted to an air-tight chamber 2 using a conveyor 1. The air-tight chamber 2 loaded with the metals is preferably disconnected from the conveyor 1, and any of the following: hydrogen, deuterium, tritium or a mixture of these isotopes in a molecular hydrogen form from the delivery system 3 is submitted to the chamber 2 and heated up to a suitable predetermined temperature and pressure to load metals with those gaseous ingredients within an effective predetermined time interval. Suitable times, temperatures and pressure may be easily determined by one of ordinary skill in the art through routine experimentation.

During the loading process with gaseous substances of the group consisting of hydrogen, deuterium, tritium, or a mixture of these isotopes in a molecular hydrogen form, the chamber 2 is also preferably disconnected from the collection system 4. After reaching the desired concentration of said ingredients in the metals, the gaseous ingredients can be submitted to the chamber 2 in a time-varying pulses, or their flow rate can be reduced to a lower level, or the delivery system 3 can be cut off completely; then the chamber 2 may be connected or disconnected with a collection system 4 or the like dependent on a predetermined operational temperature and pressure in the chamber 2; and the chamber 2 is heated up and pressurized to a suitable predetermined operational temperature and pressure to start exothermic reactions of the metal with any of the following: hydrogen, deuterium, tritium, or a mixture of these isotopes. The collection system 4 or a similar system is preferably configured to prevent a release of the radioactive gases to the environment.

In operation, considering that an initial composition of stainless steel contains nickel in a significant amount, we estimate how nickel can be used to carry out an exothermic reaction with tritium. Assuming that stable nickel isotopes react with tritium atoms the same way as hydrogen atoms, possible nuclear reactions are shown in Table 2.

TABLE 2
Estimate of energy release during nuclear reactions of nickel isotopes with tritium atoms.

| | | | Characteristics of | | ΔE, | | | | |
|---|---|---|---|---|---|---|---|---|---|
| | | | product of reaction | | MeV | | Decay product | | |
| Ni Characteristics | | | (Ni + T) | | per | ΔE, MeV | | Daughter's | |
| Atomic | | | Atomic | | atom of | per g- | | isotope, | |
| mass | | Isotope | mass | Isotope | each | atom of | Daughter's | Atomic | Isotope |
| ₂₈Ni | Abundance | status | ₂₉Cu | status | isotope | metal | isotope | Number | status |
| 58 | 68.077% | Stable | 61 | Radioactive | 16.71 | 9.92E+24 | Ni | 61 | Stable |
| 59 | | Radioactive | 62 | Radioactive | 16.59 | | Ni | 62 | Stable |
| 60 | 26.223% | Stable | 63 | Stable | 16.06 | | | | |
| 61 | 1.140% | Stable | 64 | Radioactive | 16.15 | | Ni (61%) | 64 | Stable |
| | | | | | | | Zn (34%) | | |
| 62 | 3.634% | Stable | 65 | Stable | 15.47 | | | | |
| 63 | | Radioactive | 66 | Radioactive | 15.70 | | Zn | 66 | Stable |
| 64 | 0.926% | Stable | 67 | Radioactive | 15.17 | | Zn | 67 | Stable |

As can be seen from Table 2, the probabilities of the nuclear reactions between each stable nickel isotope and tritium atoms are greater than for hydrogen atoms because energy released in each respective nuclear reaction with tritium is greater than with hydrogen. Assuming that all the nuclear reactions of stable nickel isotopes with tritium atoms also occur in parallel, the energy released by 1 g-atom of nickel (9.92E+24 MeV) is calculated based on stoichiometric concentrations of the stable nickel isotopes. Comparing the energy released during the reactions of g-atom of nickel with tritium and hydrogen shows that energy release in a reaction with tritium is by a factor of almost 4.2 greater than with hydrogen.

Tables 3-6 show possible products of the nuclear reactions of stable copper, iron, tungsten, and beryllium isotopes with tritium atoms, respectively.

TABLE 3
Estimate of energy release during nuclear reactions of stable copper isotopes with tritium atoms.

| | | | Characteristics of | | | | | | |
|---|---|---|---|---|---|---|---|---|---|
| | | | product of | | ΔE, | | | | |
| | | | reaction | | MeV | | Decay product | | |
| Cu Characteristics | | | (Cu + T) | | per | ΔE, MeV | | Daughter's | |
| Atomic | | | Atomic | | atom of | per g- | | isotope, | |
| mass | | Isotope | mass | Isotope | each | atom of | Daughter's | Atomic | Isotope |
| ₂₉Cu | Abundance | status | ₃₀Zn | status | isotope | metal | isotope | Number | status |
| 63 | 69.15% | Stable | 66 | Stable | 18.27 | 1.09E+25 | | | |
| 65 | 30.85% | Stable | 68 | Stable | 17.69 | | | | |

TABLE 4
Estimate of energy release during nuclear reactions of stable iron isotopes with tritium atoms

| | | | Characteristics of | | ΔE, | | | | |
|---|---|---|---|---|---|---|---|---|---|
| | | | product of reaction | | MeV | | Decay product | | |
| Fe Characteristics | | | (Fe + T) | | per | ΔE, MeV | | Daughter's | |
| Atomic | | | Atomic | | atom of | per g- | | isotope, | |
| mass | | Isotope | mass | Isotope | each | atom of | Daughter's | Atomic | Isotope |
| ₂₆Fe | Abundance | status | ₂₇Co | status | isotope | metal | isotope | Number | status |
| 54 | 5.845% | Stable | 57 | Radioactive | 18.04 | 1.00E+25 | Fe | 57 | Stable |
| 56 | 91.754% | Stable | 59 | Stable | 16.57 | | | | |
| 57 | 2.119% | Stable | 60 | Radioactive | 16.42 | | Ni | 60 | Stable |
| 58 | 0.282% | Stable | 61 | Radioactive | 15.69 | | Ni | 61 | Stable |

TABLE 5
Estimate of energy release during nuclear reactions of stable tungsten isotopes with tritium atoms

| | | | Characteristics of | | ΔE, | | | | |
|---|---|---|---|---|---|---|---|---|---|
| | | | product of reaction | | MeV | | Decay product | | |
| | | | (W + T) | | per | ΔE, MeV | | Daughter's | |
| W Characteristics | | | Atomic | | atom of | per g- | | isotope, | |
| | | Isotope | mass | Isotope | each | atom of | Daughter's | Atomic | Isotope |
| ₇₄W | Abundance | status | ₇₅Re | status | isotope | metal | isotope | Number | status |
| 182 | 26.500% | Stable | 185 | Stable | 10.52 | 3.46E+24 | | | |
| 183 | 14.310% | Stable | 186 | Radioactive | 10.51 | | Os | 186 | Radioactive |
| | | | | | | | (93.1%) | | |
| | | | | | | | W (6.9%) | | |
| 184 | 30.640% | Stable | 187 | Radioactive | 10.46 | | Os | 187 | Stable |
| | | | | | | | (99.99%) | | |
| | | | | | | | Ta¹⁸³ (10⁻⁴ | | |
| | | | | | | | %) | | |
| 186 | 28.430% | Stable | 189 | Radioactive | 10.42 | | Os | 189 | Stable |

TABLE 6
Estimate of energy release during nuclear reactions of stable beryllium isotopes with tritium atoms

| | | | Characteristics of | | ΔE, | | | | |
|---|---|---|---|---|---|---|---|---|---|
| | | | product of reaction | | MeV | | Decay product | | |
| Be Characteristics | | | (Be + T) | | per | ΔE, MeV | | Daughter's | |
| Atomic | | | Atomic | | atom of | per g- | | isotope, | |
| mass | | Isotope | mass | Isotope | each | atom of | Daughter's | Atomic | Isotope |
| ₄Be | Abundance | status | ₅B | status | isotope | metal | isotope | Number | status |
| 9 | 100.00% | Stable | 12 | Radioactive | 12.93 | 7.79E+24 | C (98.4%) | 12 | Stable |
| | | | | | | | Be⁸ | | |
| | | | | | | | (1.6%) | | |

Comparison of the values of energy released in the nuclear reactions of metals with tritium shows that the reactions of nickel, iron, copper, tungsten, and beryllium with tritium release greater amounts of energy than the reaction of nickel with hydrogen shown in Table 1. The highest estimate is for nuclear reactions of stable isotopes of copper with tritium: energy released is 4.6 times greater than for nickel with hydrogen.

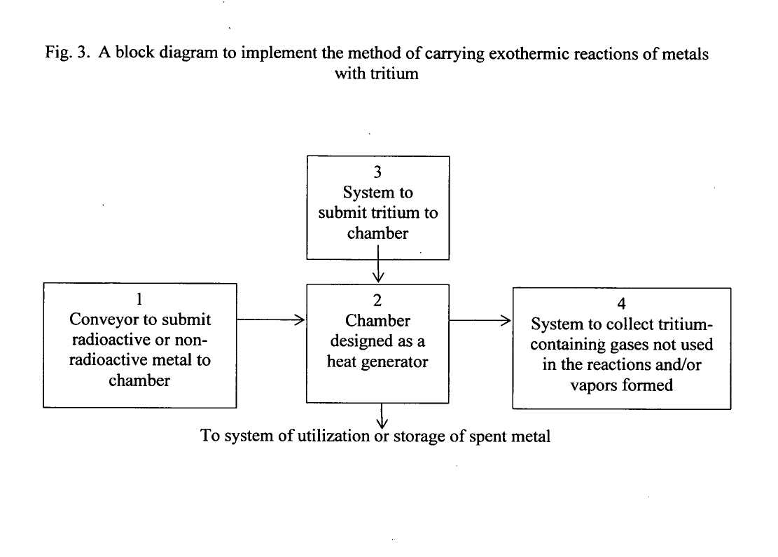

FIG. 3 depicts a block diagram of a presently preferred prophetic embodiment implementing the proposed method of carrying out exothermic reactions of metals and tritium in molecular hydrogen form according to the present invention. In operation, it is contemplated that non-radioactive or radioactive metals are submitted to an air-tight chamber 2 using a conveyor 1. The air-tight chamber 2 loaded with the metals is preferably disconnected from the conveyor 1, and tritium from the delivery system 3 is submitted to the chamber 2 and heated up to a suitable predetermined temperature to load metals with tritium within an effective predetermined time interval. Suitable times and temperatures may be easily determined by one of ordinary skill in the art through routine experimentation.

During the tritium loading process, the chamber 2 is also preferably disconnected from the collection system 4. After reaching the desired tritium activity in the metals, tritium can be submitted to the chamber 2 in a time-varying pulses, or the flow rate of tritium can be reduced to a lower level, or the delivery system 3 can be cut off completely, then the chamber 2 may be connected with a collection system 4 or the like dependent on a predetermined operational temperature and pressure inside the chamber 2; and the chamber 2 is heated up and pressurized to a suitable predetermined operational temperature and pressure to start exothermic reactions of the metal with tritium. One of ordinary skill can design the chamber 2 to generate steam or any other energy carrier using heat produced in exothermic nuclear reactions. The collection system 4 or similar system is preferably configured to prevent a release of the tritium-contaminated gases to the environment.

As will be appreciated by one of ordinary skill in the art, the thermal energy may be used to generate any other type of energy, such as steam.

The above embodiments are for illustrative purposes and are not intended to limit the scope of the invention or the adaptation of the features described herein to particular pieces of exercise equipment. Those skilled in the art will also appreciate that various adaptations and modifications of the above-described preferred embodiments can be configured without departing from the scope and spirit of the invention. Therefore, it is to be understood that, within the scope of the appended claims, the invention may be practiced other than as specifically described.

1. A method for acceleration of nuclear transmutation of radioactive isotopes of metals comprising the steps of:
placing the metals in a chamber;
exposing the metals in the chamber to gaseous substances of the group consisting of hydrogen, deuterium, tritium or a mixture of these isotopes in a molecular hydrogen form;
heating the metals in the chamber to a temperature of at least 200° C.; and
maintaining this steady temperature until radioactivity of the metals decreases to a desired level.

2. A method for acceleration of nuclear transmutation of tritium in metals comprising the steps of:
placing the metals contaminated with tritium in a chamber;
heating the metals contaminated with tritium in the chamber to a temperature of at least 200° C.; and
maintaining this steady temperature until radioactivity of the metals decreases to a desired level.

3. A method of decontamination of radioactive metal waste contaminated with tritium comprising the steps of:
placing the waste contaminated with tritium in a chamber;
heating the waste in the chamber to a temperature of at least 200° C.; and
maintaining this steady temperature until radioactivity of the waste decreases to a desired level.

4. A method of claim 3 where a purge agent is passing through the chamber during the steps of heating and steady temperature maintaining, and a gas exchange rate of the purge agent is controlled thereby leading to partial removal of tritium from the metals and partial transmutation of tritium.

5. A method of claim 4 where the metals comprise any metal of the following list: stainless steel, copper alloy, tungsten, or beryllium contaminated with tritium and the purge agent is any mixture of the following list: argon+hydrogen, nitrogen+hydrogen, or argon+water vapor.

6. A method of claim 5 where the metals comprise any metal of the following list: stainless steel, copper alloy, or tungsten contaminated with tritium comprising the steps of:
placing metals in a chamber;
heating the metals in the chamber to a temperature of substantially 800° C. at atmospheric pressure; and
maintaining this steady temperature within no less than 24 hours while simultaneously purging the chamber during the heating and maintaining steps with a mixture of 95 vol % argon+5 vol % hydrogen (the purge agent) with the gas exchange rate of no less than substantially 6 h⁻¹, which allows recovering the maximum and transmutating the minimum amounts of tritium during the decontamination process.

7. A method of claim 5 where metals comprise beryllium contaminated with tritium comprising the steps of:
placing metals in a chamber;
heating the metals in the chamber to a temperature of substantially 800° C. at atmospheric pressure; and
maintaining this steady temperature within no less than 24 hours while simultaneously purging the chamber during the heating and maintaining steps with a mixture of 95 vol % argon+5 vol % (the purge agent) with the gas exchange rate of no less than substantially 80 h⁻¹ which allows recovering the maximum and transmutating the minimum amounts of tritium during the decontamination process.

8. A method of thermal energy generation by processing radioactive metals comprising the steps of:
placing the metals in a chamber;
exposing the metals in the chamber to gaseous substances of the group consisting of hydrogen, deuterium, tritium or a mixture of these isotopes in a molecular hydrogen form;
heating the metals in the chamber to a temperature of at least 200° C.; and
maintaining this steady temperature until heat release rate of the metals is decreased to a desired level.

9. A method of thermal energy generation by processing metals with gaseous substances of the group consisting of deuterium, tritium or a mixture of these isotopes in a molecular hydrogen form comprising the steps of:
placing the metals in a chamber;
exposing the metals in the chamber to the said gaseous substances for the said substances to be absorbed by the metals;
heating the metals in the chamber to a temperature of at least 200° C.; and
maintaining this steady temperature until heat release rate of the metals is decreased to a desired level.

10. A method of decontamination of radioactive metal waste comprising the steps of placing the waste in a chamber;
exposing the waste in the chamber to gaseous substances of the group consisting of hydrogen, deuterium, tritium or a mixture of these isotopes in a molecular hydrogen form for the said substances to be absorbed by the waste;
heating the waste in the chamber to a temperature of at least 200° C.; and
maintaining this steady temperature until radioactivity of the waste is decreased to a desired level.

11. A method of thermal energy generation by processing metals contaminated with tritium comprising the steps of:
placing the metals contaminated with tritium in a chamber;
heating the metals in the chamber to a temperature of at least 200° C.; and
maintaining this steady temperature until heat release rate of the metals is decreased to a desired level.

12. A system for decontamination of metals contaminated with a plurality of radioactive isotopes comprising of:
a conveyor to submit radioactive metals to a chamber;
a heat source for heating the chamber;
a system to pump into the chamber gaseous substances of the group consisting of hydrogen, deuterium, tritium, or a mixture of these isotopes in a molecular hydrogen form;
a purge gas source in fluid communication with the chamber if needed; and
a collection system in fluid communication with the chamber for collecting gases released during heating of the said metals and purged from the said chamber.

13. A system for production of thermal energy from radioactive metals comprising:
a chamber configured to accept metals; and expose them to gaseous substances of the group consisting of hydrogen, deuterium, tritium, or a mixture of these isotopes in a molecular hydrogen form, wherein exothermic reactions, which involve the substances, occur in the chamber;
a controller configured to control the rate of supply of the gaseous substances to the said chamber; and,
a collection system to collect the ingredients not used in the reaction and other radioactive gases released during the reactions.

14. A system for production of thermal energy from non-radioactive metals comprising:
a chamber configured to accept metals; and expose them to gaseous substances of the group consisting of deuterium, tritium, or a mixture of these isotopes in a molecular hydrogen form, wherein exothermic reactions, which involve the gaseous substances, occur in the chamber;
a controller configured to control the rate of supply of the gaseous substances to the said chamber; and,
a collection system to collect the gaseous substances not used in the reaction and other radioactive gases released during the reactions
